(19) United States
(12) Patent Application Publication
(10) Pub. No.: US 2026/0244383 A1
(43) Pub. Date: Aug. 20, 2026

(54) IMAGE FORMING SYSTEM, METHOD FOR CONTROLLING IMAGE FORMING SYSTEM, AND NON-TRANSITORY COMPUTER-READABLE STORAGE MEDIUM

(71) Applicant: Konica Minolta, Inc., Tokyo (JP)

(72) Inventors: Shinya SAITO, Tokyo (JP); Yasushi TSUE, Tokyo (JP); Fuhito NAKAGAWA, Tokyo (JP)

(21) Appl. No.: 19/543,455

(22) Filed: Feb. 18, 2026

(30) Foreign Application Priority Data
Feb. 20, 2025 (JP) 2025-025639

(51) Int. Cl. G06F 3/12

(52) U.S. Cl. CPC G06F 3/126; G06F 3/1203

(57) ABSTRACT

The present invention provides an image forming system, a method for controlling the image forming system, and a control program with which it is possible to provide a printed material according to the schedule of a shipping work for shipping a product. The image forming system generates a printed material to be sent together with the ordered product. The image forming system has a hardware processor, and the hardware processor is provided with a controller that controls a process of generating the printed material on the basis of information regarding a timing for sending the product.

### CROSS-REFERENCE TO RELATED APPLICATION

Japanese patent application No. 2025-025639 filed on Feb. 20, 2025, including description, claims, drawings, and abstract the entire disclosure is incorporated herein by reference in its entirety.

### BACKGROUND OF THE INVENTION

### 1. Technical Field

The present invention relates to an image forming system, a method for controlling the image forming system, and a non-transitory computer-readable storage medium storing a control program.

### 2. Description of Related Art

In recent years, business to consumer (B to C) transactions through electronic commerce (EC) sites have tended to increase. A product purchased through an EC site is packed in a cardboard box or the like or enclosed in an envelope or the like in a distribution center and delivered to a consumer (orderer). At this time, a printed matter such as a leaflet related to the product is often sent together with the product.

At present, an operator picks up necessary leaflets from leaflets printed in advance in a printing company or the like and stored in a large amount in a warehouse of a distribution center in accordance with an instruction of an EC company, and stacks the leaflets in a designated order to manually create a set of leaflets. The created set of flyers is bundled or enclosed together with the product at the time of shipment of the product.

Such a set of flyers is, for example, created by a worker in advance in his/her spare time for each product purchased by a customer or for each number of purchases, and is stored for each product in many boxes arranged on a predetermined shelf. A set of flyers is picked from the shelf by the worker when the set of flyers is bundled with a product. Creating a set of flyers in advance facilitates the picking work performed by the worker, but if the set of flyers to be bundled with the product is changed due to the flyers having limited-time information, the worker needs to recreate the set of flyers. Further, when a set of leaflets to be packed together is changed, a leaflet which cannot be used has to be discarded. Further, when there are flyers that can be still used, a space for storing such flyers is required.

In addition, a schedule of shipment work of commodities in the distribution center is managed, and in order to avoid storage of surplus leaflets generated due to delay of the work, it is necessary to generate printed matters such as leaflets according to the schedule.

In this connection, Japanese Unexamined Patent Publication No. 2010-257054 discloses performing a shipping operation using printed matter printed by a printer when the number of copies in stock in a stock shelf that manages the stock of printed matter is less than the number of copies ordered.

### SUMMARY OF THE INVENTION

The technique disclosed in Japanese Unexamined Patent Application Publication No. 2010-257054 makes it possible to compensate for the shortage of the printed materials in the stock shelf by using the printed materials printed by the printer, but does not consider the schedule of the shipping work. Therefore, in a case where shipping work is delayed and surplus flyers are generated, a space for storing such surplus flyers is needed.

The present invention has been made in view of the above-mentioned circumstances. An object of the present invention is to provide an image forming system, a method for controlling the image forming system, and a non-transitory computer-readable storage medium storing a control program with which it is possible to provide a printed material according to the schedule of a shipping work for shipping a product.

To achieve at least one of the abovementioned objects, according to an aspect of the present invention, an image forming system reflecting one aspect of the present invention comprises the followings.

An image forming system for generating a printed material to be sent together with an ordered product includes a hardware processor, and the hardware processor controls a process of generating the printed material based on information regarding a timing for sending the product.

### BRIEF DESCRIPTION OF THE DRAWINGS

Advantages and features provided by one or more embodiments of the present invention will be more fully understood from the following detailed description and the accompanying drawings, which are for purposes of illustration only and are not intended to define the limits of the invention.

FIG. 1 is a schematic block diagram illustrating the configuration of an electronic commerce system according to a first embodiment;

FIG. 2 is a schematic block diagram illustrating the configuration of the image forming system illustrated in FIG. 1;

FIG. 3 is a schematic block diagram illustrating the configuration of a print information acquirer illustrated in FIG. 2;

FIG. 4 is a schematic diagram illustrating composition setting information;

FIG. 5 is a schematic block diagram illustrating the configuration of a document data generator illustrated in FIG. 2;

FIG. 6 is a schematic block diagram illustrating a configuration of a print job generating section illustrated in FIG. 2;

FIG. 7 is a schematic block diagram illustrating the configuration of an image forming apparatus illustrated in FIG. 1;

FIG. 8 is a schematic block diagram illustrating the configuration of a controller illustrated in FIG. 7;

FIG. 9 is a flowchart illustrating the procedure of a method for printing a flyer in the EC system;

FIG. 10 is a schematic diagram illustrating a pattern table of a flyer to be bundled with a product; and

FIG. 11 is a schematic diagram illustrating, as a comparative example, a shelf on which many boxes for storing flyers are arranged.

### DETAILED DESCRIPTION

Embodiments of the present invention will be described below with reference to the drawings. It is to be noted that the scope of the present invention is not limited to the disclosed embodiments. In the description of the drawings, the same components are denoted by the same reference signs, and the redundant description is omitted. In addition, dimensional ratios in the drawings are exaggerated for convenience of description and may be different from actual ratios.

### (Example of Electronic Commerce System)

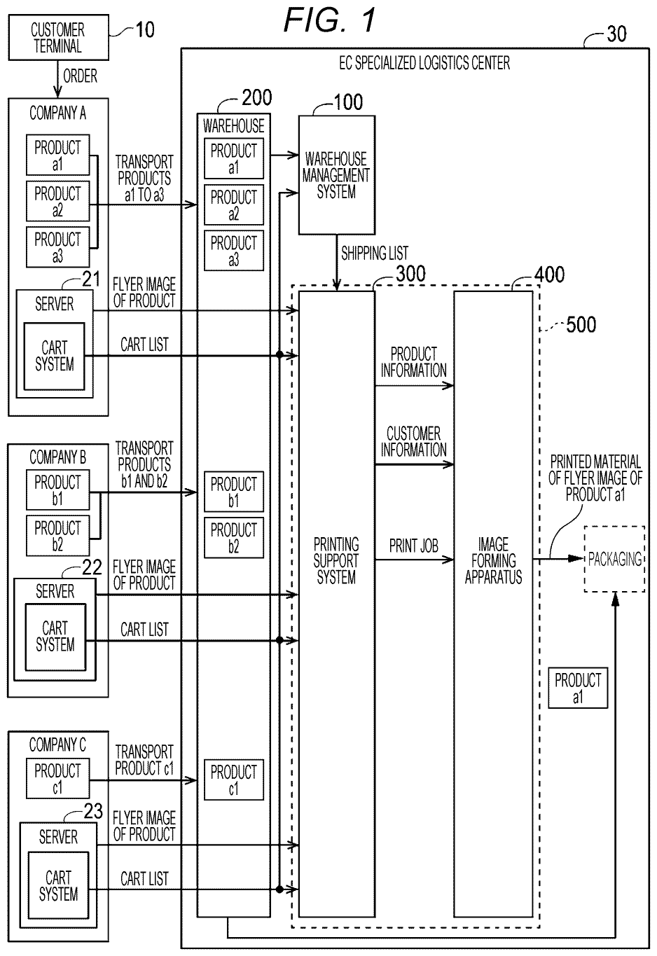

FIG. 1 is a schematic block diagram illustrating the configuration of an electronic commerce (EC) system according to a first embodiment. In this EC system, a customer (orderer) uses the customer terminal 10 to order a product from Company A, Company B, or Company C as an EC business operator. FIG. 1 illustrates a case where an order is placed with the company A from the customer terminal 10. In a case where the customer orders products from the company B and the company C, the orders are similarly placed with the company B and the company C, although this is not illustrated.

An order for a product is placed through a cart system installed in each of company A, company B, and company C. The drawing illustrates a case where the products of the company A are a1 to a3, the products of the company B are b1 and b2, and the product of the company C is c1. It should be noted that FIG. 1 does not illustrate the quantity of inventory of each product.

The EC-specialized distribution center 30 is a distribution center specialized for EC. The inventory of the products of each company in a warehouse 200 is managed by a warehouse management system 100. The products are transported from the companies A, B, and C to the EC specialized logistics center 30 according to the remaining number of the products, and are supplied to the warehouse 200.

The EC specialized logistics center 30 is provided with the warehouse management system 100, the warehouse 200, a printing support system 300, and an image forming apparatus 400 as constituent elements of the EC system. The warehouse management system 100 and the printing support system 300 may be implemented by an on-premise server (computer) or may be implemented by a cloud server.

When a product is ordered by the customer, a picking list is output from the image forming apparatus 400 in response to the order in the EC specialized logistics center 30. The picking list is also referred to as a shipping instruction, and is a list including information (for example, a storage location of a product, a product code, a quantity, and the like) necessary for the picking work by a worker. The worker who is in charge of shipping the product checks the picking list, picks the product stored in the product storage area of the warehouse 200, acquires a printed material of a flyer image of the product, inspects the product and the printed material, and then packs the product together with the printed material in a cardboard box. Note that the product may be picked using a machine (e.g., material handling). Furthermore, the flyer image of the product is not limited to the flyer of the ordered product, but includes a flyer image of a product or a service related to the ordered product.

The printed matter of the flyer image of the product can be ejected to a sheet ejection tray of the image forming apparatus 400 in accordance with the timing at which the worker sends the product. In the present embodiment, the timing for sending the product includes, for example, the shipment timing for shipping the product, the timing based on the date and time of receipt designated by the orderer who ordered the product, and the like. The discharge order of the printed matters by the image forming apparatus 400 corresponds to, for example, the order in which the products are packed together with the printed matters.

The companies A to C which are EC companies are provided with servers 21 to 23 as constituent elements of the EC system, respectively. The cart system is realized by the servers 21 to 23.

The warehouse management system 100, the warehouse 200, the printing support system 300, and the image forming apparatus 400 which are included in the EC specialized logistics center 30, the customer terminal 10, and the servers 21 to 23 of the companies A to C constitute the EC system according to the present embodiment.

### (Customer Terminal 10)

The customer terminal 10 is, for example, a computer such as a personal computer, a smartphone, or a tablet terminal that is used by the customer to order a product. The customer terminal 10 includes input/output devices such as a touch screen, a keyboard, and a mouse (not illustrated). The customer performs operations such as searching for a product, selecting a product that the customer desires to purchase, and determining a payment method, using the input/output device of the customer terminal 10 at, for example, a shopping site provided on the Internet by the EC company.

### (Servers 21 to 23)

The servers 21 to 23 are computers installed in the companies A to C, respectively, and each execute a cart system to output a cart list in response to a customer's order. The cart list includes information regarding the product ordered by the customer, information about the customer such as the name and the address, a pickup request to the warehouse management system 100, and the like. The cart system is a system that provides a mechanism for allowing a customer to order a product and pay for the product on the Internet. In the mechanism provided by the cart system, a customer searches for a product on an EC site or a mail-order website, places the product that the customer wants to purchase in a shopping cart, and performs a purchase procedure to order the product. For the product for which the purchase procedure has been performed, payment is performed with, for example, a credit card. The cart system may have an order reception management function, a customer management function, a product management function, a sales promotion management function, and the like in addition to the cart function and the settlement function. The customer shops using a virtual shopping cart (basket) displayed on the screen of the customer terminal 10. For example, the customer can select a desired product by placing the product in a shopping cart in the same manner as that when the customer shops in a real store.

The servers 21 to 23 generate information regarding the product and information regarding the customer from information that is input when the customer orders the product. In the following, the information regarding a product is also referred to as product information, and the information regarding a customer is also referred to as customer information. The product information includes, for example, information related to a product storage area in the warehouse 200 and a delivery company that delivers the product, in addition to information specific to the product such as the name, the manufacturing number, and the manufacturing date of the product. The customer information includes information such as the customer's name, address, contact information, and the number of purchases for each product.

Furthermore, the servers 21 to 23 transmit a flyer image of a product created in advance by the EC company to the printing support system 300.

### (EC-Specialized Logistics Center 30)

### <Warehouse Management System 100>

The warehouse management system 100 is a WMS (Warehouse Management System), and has functions such as warehousing/delivery management and inventory management of products in the warehouse 200. Upon receiving the shipping instruction, the warehouse management system 100 generates a management number on the basis of the cart list and information acquired from the warehouse 200. The management number is a number managed by the warehouse management system 100 and the cart system in cooperation with each other. The shipping instruction can be generated, for example, on the basis of a shipment request transmitted to the warehouse management system 100 from each cart system when the cart system receives an order from a customer. The shipping request may be included in the cart list, for example. The warehouse management system 100 generates, every several hours to a day, a shipping list in which a management number and an instruction (order) regarding a product to be picked up from the warehouse 200, the quantity of the product, and the like are described, and transmits the generated shipping list to the printing support system 300. The shipment list includes information on shipment timing of the product, such as a shipment date and time.

In the example illustrated in FIG. 1, the warehouse 200 stores therein the products a1 to a3 transported from the company A, the products b1 and b2 transported from the company B, and the product c1 transported from the company C. In the warehouse 200, a sensor for detecting the remaining number of products is arranged, and information regarding the remaining number of products is sequentially transmitted to the warehouse management system 100. For example, when the remaining number of products stored in the warehouse 200 is zero or becomes small, a signal requesting supply of products can be transmitted from the warehouse 200 to the warehouse management system 100.

### <Image Forming System 500>

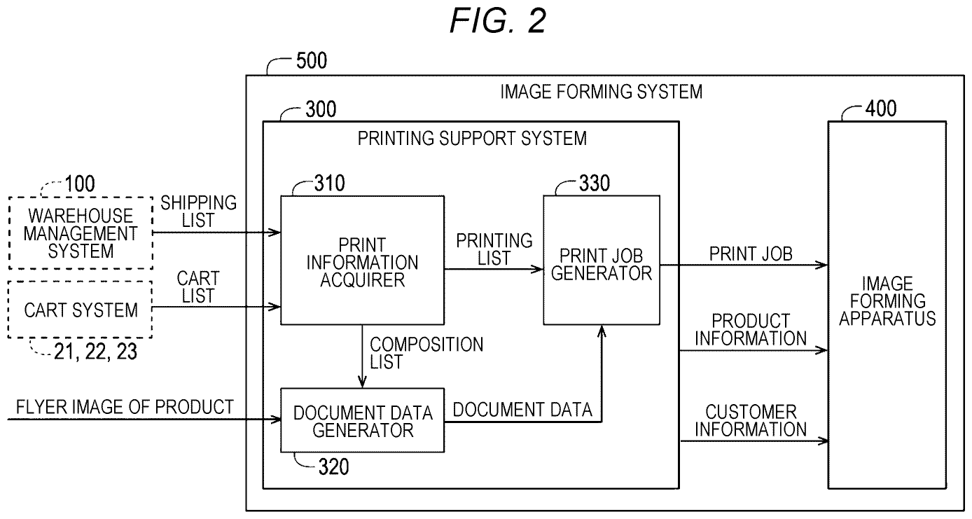

FIG. 2 is a schematic block diagram illustrating the configuration of the image forming system 500 illustrated in FIG. 1. The image forming system 500 is a system that generates a printed material to be sent together with an ordered product. Here, in the present specification, sending the product and the printed matter at the same time means sending the printed matter together with the product in a bundled or enclosed manner. The image forming system 500 includes a printing support system 300 and an image forming apparatus 400.

The image forming system 500 according to the present embodiment controls a process of generating the printed material based on the information regarding the timing for sending the product. The process of generating the printed material includes, for example, generation, transmission, and execution of a print job. As illustrated in Table 1 below, subjects to be controlled by controlling the process of generating the printed material include a timing of generation of the print job, a timing of transmission of the print job, and a timing of execution of the print job. The timing of generation of the print job and the timing of transmission of the print job are mainly controlled by the printing support system 300, and the timing of execution of the print job is mainly controlled by the image forming apparatus 400.

TABLE 1

| | | Information regarding timing for sending product | | |
|---|---|---|---|---|
| | | | | Timing based on |
| | | | | date and time of |
| | | Shipment timing for product | | receipt of product |
| | Subject to be | | Work timing for | Date and time of |
| | controlled | Stock | shipment | receipt |
| Control of process | Timing of | Mainly controlled | Mainly controlled | Mainly controlled |
| of generating | generation | by: printing support | by: printing support | by: printing support |
| printed material | of print job | system | system | system |
| | | Parameter: scheduled | Parameter: scheduled | Parameter: |
| | | shipping date | shipping date | designated delivery |
| | | | | date, designated |
| | | | | delivery time slot, |
| | | | | desired delivery |
| | | | | time, etc. |
| | Timing of | Mainly controlled | Mainly controlled | Mainly controlled |
| | transmission | by: printing support | by: printing support | by: printing support |
| | of print job | system | system | system |
| | | Parameter: scheduled | Parameter: scheduled | Parameter: |
| | | shipping date | shipping date | designated delivery |
| | | | | date, designated |
| | | | | delivery time slot, |
| | | | | desired delivery |
| | | | | time, etc. |
| | Timing of | Mainly controlled | Mainly controlled | Mainly controlled |
| | execution of | by: image forming | by: image forming | by: image forming |
| | print job | apparatus | apparatus | apparatus |
| | | | | Parameter: |
| | | | | designated delivery |
| | | | | date, designated |
| | | | | delivery time slot, |
| | | | | desired delivery |
| | | | | time, etc. |

The information regarding the timing for sending the product may be, for example, the shipment timing for the product, the timing based on the date and time of receipt designated by the orderer who ordered the product, or the like. In order to ship a product, for example, a worker needs to check whether the product is in stock in the warehouse 200 and perform shipping work. That is, the shipment timing for the product can be specified based on whether or not the product is in stock. In addition, the shipping work includes, for example, a work for picking the product, a work for bundling the printed material with the product, a work for loading the product, and the like. The shipment timing for the product can be specified based on the work timing of shipment. The shipment timing for the product can be determined, for example, based on parameters such as the scheduled shipping date included in the shipment timing information. Furthermore, the timing based on the date and time of receipt can be determined based on parameters such as a designated delivery date, a designated delivery time slot, and a desired delivery time slot included in the shipment timing information.

### <Printing Support System 300>

The printing support system 300 is a system for supporting printing by the image forming apparatus 400, and constitutes the image forming system 500 together with the image forming apparatus 400. The printing support system 300 includes a print information acquirer 310, a document data generator 320, and a print job generator 330. The printing support system 300 outputs a printing job on the basis of the shipping list, the cart list, and the flyer image of the product.

The printing support system 300 functions as an information processing apparatus, and generates a print job for generating a printed material to be sent together with a product in response to a customer's order for the product. When generating a print job, the printing support system 300 can change documents to be used in printing and the stacking order of the documents with composition, and change the timing of generation or transmission of the print job. The printing support system 300 starts the processing of generating the printing job, for example, at a timing when the shipping list is imported from the warehouse management system 100 to the printing support system 300.

### [Print Information Acquiring Section 310]

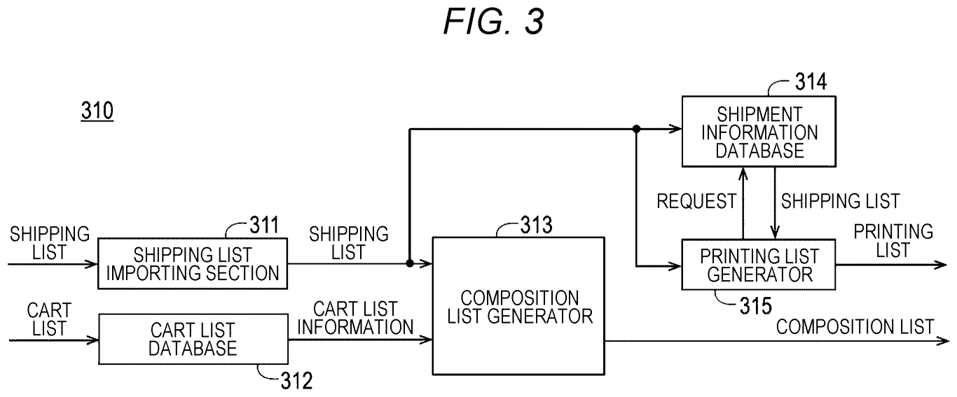

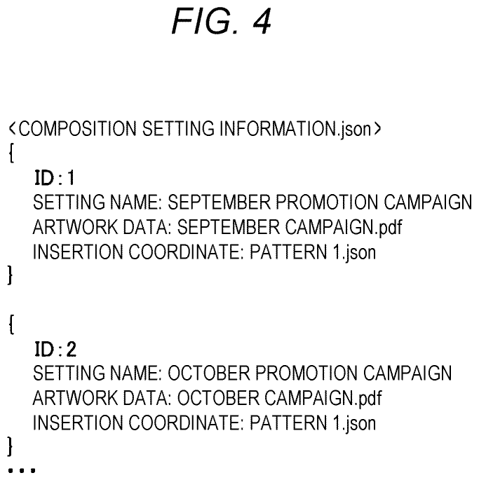

FIG. 3 is a schematic block diagram illustrating the configuration of the print information acquirer 310 illustrated in FIG. 2. FIG. 4 is a schematic diagram illustrating composition setting information. The print information acquirer 310 includes a shipping list importing section 311, a cart list database 312, a composition list generator 313, a shipment information database 314, and a printing list generator 315.

The print information acquirer 310 generates a composition list and a printing list on the basis of the shipping list and the cart list. The composition list is information obtained by combining the customer information included in the cart list with the order described in the shipping list by the management number, and is a list required when the document data is subjected to variable printing. The printing list is a list in which orders to be printed among the orders listed in the shipping list are arranged in the order of printing.

### [Shipping List Importing Section 311]

The shipping list importing section 311 imports the shipping list output from the warehouse management system 100 and outputs the shipping list to the composition list generator 313. The shipping list includes a list of items to be shipped and shipping timing information for each item. The shipment timing information can include, for example, information regarding a designated delivery date, a scheduled shipping date, a desired delivery time, a designated delivery time slot, and the like.

### [Cart List Database 312]

The cart list database 312 stores, in a database, the cart lists input from the cart systems of the companies A to C. In response to a request from the composition list generator 313, the cart list database 312 outputs the cart list information stored in the database to the composition list generator 313. The cart list information can be read from the database by the composition list generator 313 at a necessary timing, although the cart list information and the order described in the shipping list are not necessarily synchronized with each other for the ordered product. Since the cart system transmits the shipment request to the warehouse management system 100 after receiving the order from the customer, all the information corresponding to the order described in the shipment list is included in the cart list information.

### [Composition List Generator 313]

The composition list generator 313 generates a composition list based on the shipping list and the cart list information, and outputs the composition list to the document data generator 320. The composition list generator 313 compares an order described in the shipping list with database information in the cart list, and combines customer information corresponding to the order described in the shipping list with the shipping list to generate a composition list. When doing so, the composition list generator 313 also describes, for each order in the composition list, composition setting information which defines rules for generating a variable document.

The composition list generator 313 can switch the composition setting information according to the shipment timing information described in the shipping list. As illustrated in FIG. 4, the composition setting information is information having a structure including an ID, a setting name, artwork data, and insertion coordinates. FIG. 4 illustrates data with ID 1 and data with ID 2. For example, in the ID: 1 data, a setting name is “September promotion campaign”, artwork data is “September campaign.pdf”, and insertion coordinates are “pattern 1.json”. The artwork data is base data into which variable information is inserted in variable printing, and corresponds to a flyer image of a product in the present embodiment. The insertion coordinates are coordinates into which variable information is to be inserted. A flyer image of a product is stored in advance, for example, in the document data generator 320 which will be described later, in association with the product.

The composition list generator 313 extracts corresponding data in the composition setting information depending on the shipment timing information. For example, when the scheduled shipping date in the shipment timing information for an order in the shipping list is August or early September, a flyer of the “September promotion campaign” is appropriate, and thus the composition list generator 313 determines that the ID: 1 data in the composition setting information is appropriate. In this case, ID: 1 is described in the composition list as the composition setting information for the order.

As described above, in the present embodiment, the composition list generator 313 can select the document data to be printed, that is, the image to be formed on the sheet by switching the artwork data in the composition setting information according to the shipment timing information. As a result, when a flyer of the promotion campaign, a flyer having limited-time information, or the like is used as artwork data, the composition list generator 313 can select artwork data having the detail suitable for the time of shipment of a product.

The composition list generator 313 can also switch the composition setting information according to the customer information described in the cart list. Although not illustrated, the composition setting information can include a setting name, artwork data, and insertion coordinates corresponding to the number of purchases of the product.

### [Shipment Information Database 314]

The shipment information database 314 is a database that stores the shipping list imported by the shipping list importing section 311. The shipment information database 314 outputs the past shipping list information stored in the database in response to a request from the printing list generator 315.

### [Printing List Generator 315]

The printing list generator 315 generates a printing list on the basis of the shipping list. More specifically, the printing list generator 315 determines a subject to be printed from a plurality of orders described in the shipping list on the basis of the shipment timing information included in the shipping list, and generates a printing list. The printing list generator 315 also refers to the past shipping list information stored in the shipment information database 314 and adds it to the printing list. More specifically, the printing list generator 315 determines an order to be printed from the shipment timing information described in the shipping list after the composing processing by a composition execution section 321 (to be described later) is normally completed, and adds the order to be printed at that timing to the printing list. At that time, the printing list generating section 315 refers to the past shipment information in the shipment information database 314, determines the printing order from the shipment timing information, and adds the printing order to the printing list.

In the present embodiment, the printing list generator 315 functions as a controller that controls the process of generating a printed material. More specifically, the controller can control the timing of generation of the print job by generating the printing list based on the information regarding the timing for sending the product.

### [Document Data Generating Section 320]

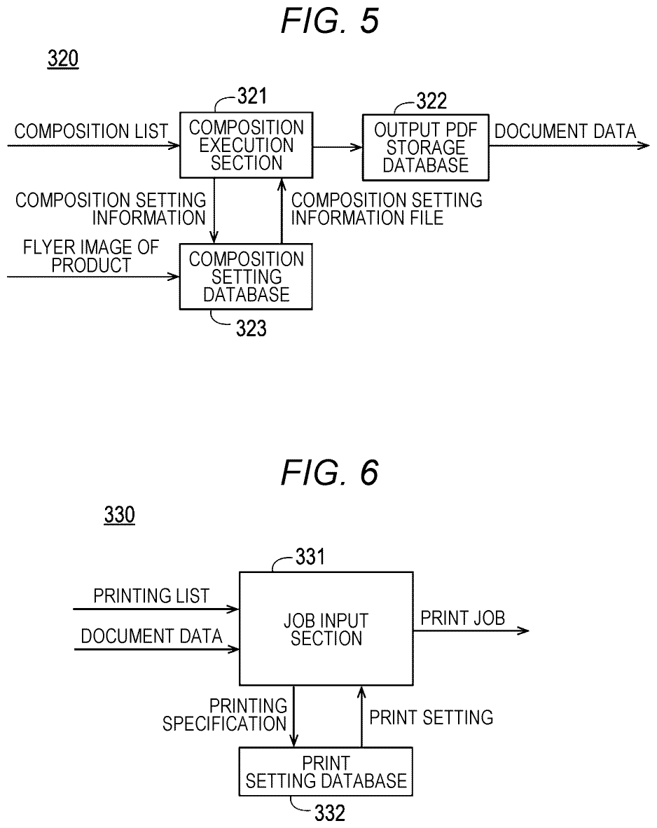

FIG. 5 is a schematic block diagram illustrating the configuration of the document data generator 320 illustrated in FIG. 2. The document data generator 320 generates document data based on the flyer image of a product and the composition list, and outputs the generated document data to the print job generator 330. The document data generator 320 includes the composition execution section 321, an output portable document format (PDF) storage database 322, and a composition setting database 323.

The composition execution section 321 executes composing processing based on the composition list, and generates document data to be printed. The generated document data is saved in the output PDF storage database 322. When performing the composing processing, the composition execution section 321 reads, from the composition setting database 323, information necessary for the composing processing according to the composition setting information. The information necessary for the composing processing is stored in the composition setting database 323. The information necessary for the composing processing includes, for example, a composition setting information file in which the detail of the composition setting information mentioned above is described. The composition setting information file is described in, for example, the JSON format. JSON is an abbreviation for JavaScript Object Notation. The composition setting information file can include an artwork data file serving as a base into which variable information is inserted, an insertion coordinate file indicating coordinates into which the variable information is inserted, image data for insertion, and the like. The insertion coordinate file may also be a JSON file.

### [Print Job Generator 330]

FIG. 6 is a schematic block diagram illustrating the configuration of the print job generator 330 illustrated in FIG. 2. The print job generator 330 generates a print job based on the printing list and the document data and outputs the print job. The generated print job is transmitted to the image forming apparatus 400. The print job generator 330 includes a job input section 331 and a print setting database 332.

The job input section 331 reads the print settings stored in the print setting database 332 on the basis of the printing specifications described in the printing list. The print settings include, for example, the number of pages, the number of copies, the type of sheet (recording medium), the size, the basis weight, single-sided printing/double-sided printing, post-processing (stapling, bookbinding), marking (barcode, QR code), and the like. The job submission unit 331 generates a print job based on the read print settings and the document data.

The job input section 331 can also include a buffer that stores a plurality of generated print jobs. The job input section 331 can control the timing of transmission of a plurality of print jobs stored in the buffer on the basis of the shipment timing information included in the printing list. For example, it is assumed that a plurality of print jobs having different shipment dates are stored in the buffer. Based on the shipment timing information, the job input section 331 can perform control to transmit, to the image forming apparatus 400, a print job to be sent on a specific day (for example, today) among the plurality of print jobs stored in the buffer.

### <Image Forming Apparatus 400>

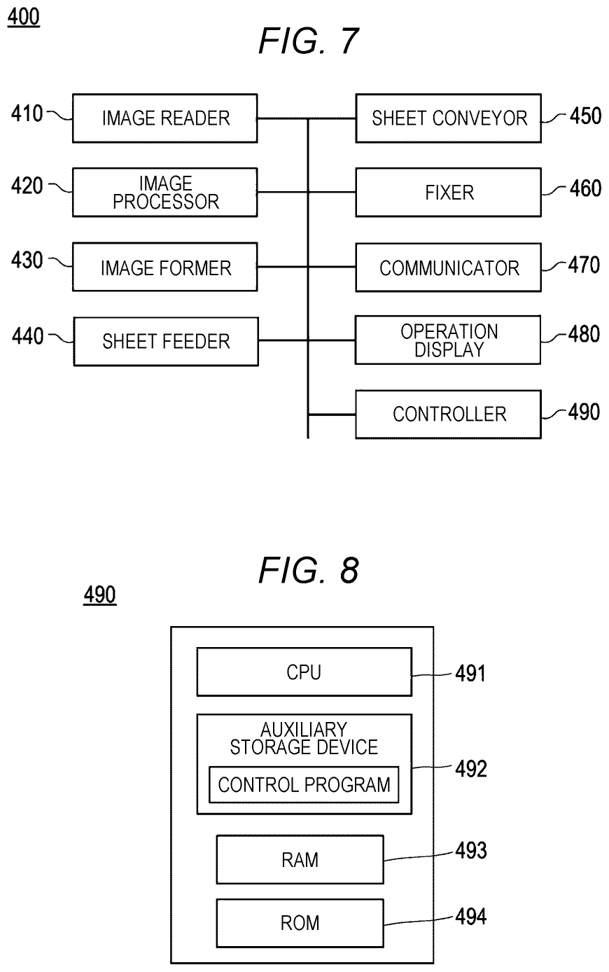

FIG. 7 is a schematic block diagram illustrating the configuration of the image forming apparatus 400 illustrated in FIG. 1, and FIG. 8 is a schematic block diagram illustrating the configuration of the controller 490 illustrated in FIG. 7. The image forming apparatus 400 receives a print job from the print support system 300 and forms (prints) an image on a sheet (recording medium). The print job includes, for example, print data in a page description language (PDL) format and print settings. The print data includes, for example, data of first to N-th pages. In the present embodiment, the image forming apparatus 400 generates a printed product to be conveyed together with a product.

The image forming apparatus 400 includes an image reading unit 410, an image processing unit 420, an image forming unit 430, a sheet feeding unit 440, a sheet conveying unit 450, a fixing unit 460, a communication unit 470, an operation display unit 480, and a control unit 490. These constituent elements are connected to one another by an internal bus.

### [Image Reader 410]

The image reader 410 includes an optical system including a mirror, a lens, and the like, and a reading sensor. The image reader 410 reads a document placed on a reading surface or a document conveyed by an auto document feeder (ADF), and outputs an image signal.

### [Image Processor 420]

The image processor 420 generates print image data on the basis of print data and print settings included in the print job received from the printing support system 300 through the communicator 470. More specifically, the image processor 420 analyzes the print job received from the printing support system 300, and performs processing such as color conversion, screening, and rasterization on each page of the print data to generate print image data in a bitmap format. The image processor 420 includes a buffer (memory) that temporarily stores a plurality of print jobs received from the printing support system 300. The image processor 420 also includes an image memory that temporarily stores the generated print image data.

The image processor 420 generates print image data by performing various types of image processing on the image signal received from the image reader 410. The generated print image data is transmitted to the image former 430.

### [Image Former 430]

The image former 430 forms an image on a sheet on the basis of print image data using a known image forming process such as an electrophotographic method including charging, exposing, developing, and transferring. The image former 430 includes a photosensitive drum which is an image bearing member, and a charger, an optical writer, a developing device, and a transferer which are disposed around the photosensitive drum.

The photosensitive drum is rotated at a predetermined speed by a drum motor (not illustrated). The charger includes a corona discharge pole disposed around the photosensitive drum, and charges the surface of the photosensitive drum with generated ions. The optical writer has a scanning optical device incorporated therein, and exposes the charged photosensitive drum based on the input print image data to reduce the potential of the exposed portion, thereby forming a charge pattern (electrostatic latent image) corresponding to the print image data. The developing device develops the formed electrostatic latent image and visualizes it with toner to form a toner image. The transferer transfers the toner image on the photosensitive drum to a sheet.

### [Sheet Feeder 440]

The sheet feeder 440 supplies a sheet as a recording material to the image former 430. The sheet feeder 440 includes an upper tray and a lower tray, and the trays can store sheets of different sizes such as A4 and A3 sizes.

### [Sheet Conveyor 450]

The sheet conveyor 450 conveys a sheet in the image forming apparatus 400. The sheet conveyor 450 includes a conveyance path and a plurality of conveyance roller pairs for conveying a sheet. Furthermore, the sheet conveyance section 450 includes a sheet reversing section that reverses the front and back of the sheet subjected to fixing by the fixing section 460 and ejects the sheet. Further, the sheet conveyor 450 is also provided with a circulation conveyor for supplying the sheet subjected to the fixing to the image former 430 again. The control unit 490 controls the sheet conveying unit 450 to supply the sheet reversed by the sheet reversing unit to the image forming unit 430 again by the circulation conveying unit, thereby forming images on both sides of the sheet.

The sheet fed from the sheet feeder 440 is conveyed through a conveyance path toward the image former 430. The sheet is synchronized with the toner image formed on the photosensitive drum at a registration roller pair, and a timing at which the sheet is conveyed to the transferer is controlled. The sheet on which the toner image has been transferred by the transferer is conveyed to the fixer 460. Next, the sheet on which the image is fixed in the fixing section 460 is conveyed to a circulation conveyance section or ejected to a sheet ejection tray.

### [Fixing Unit 460]

The fixer 460 fixes a toner image formed on the sheet. The fixer 460 includes a hollow heating roller having a heater therein and a pressure roller facing the heating roller. The heating roller and the pressure roller are controlled at a predetermined temperature (e.g., 160° C. or more) by the heater and apply heat and pressure to the sheet to fix the toner image.

### [Communicator 470]

The communicator 470 is connected to, for example, a client terminal via a communication line and transmits and receives data such as jobs.

### [Operation Display 480]

The operation display 480 includes an input section and an output section. The input section includes, for example, a keyboard and a touch screen, and is used for a worker to perform various kinds of instructions (inputs) such as character input, various kinds of settings, and a start instruction. The output section includes a display, and is used to present, to the worker, a device configuration, an execution status of a job, post-processing executable conditions, an output image, an occurrence status of abnormality (jam) in sheet conveyance, and the like.

### [Controller 490]

The control unit 490 controls the image reading unit 410, the image processing unit 420, the image forming unit 430, the sheet feeding unit 440, the sheet conveying unit 450, the fixing unit 460, the communication unit 470, and the operation display unit 480. As illustrated in FIG. 8, the controller 490 includes a CPU 491, an auxiliary storage device 492, a RAM 493, and a ROM 494.

The CPU (hardware processor) 491 controls each section of the image forming apparatus 400 by executing a control program for the image forming apparatus. The control program is stored in the auxiliary storage device 492 and is loaded onto the RAM 493 when the program is executed by the CPU 491. The auxiliary storage device 492 includes, for example, a large-capacity storage device such as a hard disk drive and a flash memory. The RAM 493 stores a calculation result or the like accompanied by the execution of the CPU 491. The ROM 494 stores various parameters, various programs, and the like. The CPU 491 realizes various functions by executing a control program for the image forming apparatus.

In the present embodiment, the controller 490 executes the control program to control the process of generating the printed material based on the information regarding the timing for sending the product. For example, the controller 490 can control the timing of execution of the print job based on the information regarding the timing for sending the product. The detail of a method for controlling the timing of execution of the print job will be described later.

### <Method for Printing Leaflet in EC System>

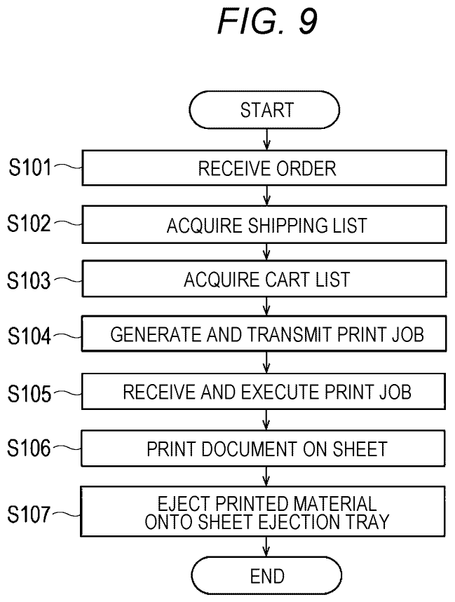

FIG. 9 is a flowchart illustrating the procedure of a method for printing a flyer in the EC system; Hereinafter, a case where the customer orders the commodity a1 of the company A will be exemplified. The same applies to a case where the customer orders another product of the A company or a product of the B company or the C company. The process of step S101 in FIG. 9 is implemented by the server 21 of the company A. In addition, the processes of steps S102 to S104 in the same figure are implemented by the server of the EC-specialized logistics center 30. Furthermore, the processes of steps S105 to S107 in FIG. 9 are implemented by the CPU 491 of the image forming apparatus 400 executing the control program.

First, the customer operates the customer terminals 10 to place an order for a commodity a1 on the EC site of the company A. The customer terminal 10 transmits ordering information to the cart system of the company A. The ordering information may include, for example, information such as an order date and time of the item a1, an item name, a quantity, a customer's name, address, contact information, a delivery destination name, and a delivery destination address.

The cart system of the company A receives the order (step S101), and generates product information about the product a1 and the customer information based on the received ordering information and the production information (e.g., the serial number, the date of manufacture, the manufacturing line, etc.) about the product a1. The cart system of the company A outputs a cart list including the product information and the customer information to the warehouse management system 100 and the printing support system 300.

Upon receiving the shipping instruction, the warehouse management system 100 generates a management number and creates a shipping list of the item, based on the cart list and the information on the inventory item acquired from the warehouse 200.

Next, the print information acquirer 310 acquires a shipping list (step S102). More specifically, the shipping list importing section 311 imports the shipping list and transmits the imported shipping list to the composition list generator 313 and the shipment information database 314. The shipping list is stored in the shipment information database 314.

Next, the print information acquirer 310 acquires a cart list (step S103). The acquired cart list is saved in the cart list database 312.

The composition list generator 313 generates a composition list based on the shipping list and the cart list information, and outputs the composition list to the document data generator 320. A document data generation part 320 generates document data on the basis of a composition list and a composition setting information file stored in a composition setting database 323. The printing list generator 315 generates a printing list on the basis of the shipment timing information included in the shipping list. Next, the print job generating section 330 generates a print job based on the print list and the document, and sends the print job to the image forming apparatus 400 (step S104).

As described above, in the present embodiment, the printing list generator 315 generates a printing list on the basis of the shipment timing information. As described above, the timing at which the printing list is generated can be changed in accordance with the shipment timing information. Therefore, the printing list generator 315 can control the timing at which the print job is generated by controlling the timing at which the printing list is generated with the shipment timing information.

Further, the print job generation unit 330 generates a print job based on the print list and transmits the print job to the image forming apparatus 400. The print job generator 330 can control the timing of transmission of the print job according to the shipment timing information in the printing list. For example, the print job generator 330 can store the generated print job in a buffer in advance before the timing for sending the product, and transmit the print job stored in the buffer to the image forming apparatus 400 when the timing for sending the product has come.

Next, the image processing unit 420 receives the print job through the communication unit 470 and stores the print job in the buffer. The image processing unit 420 executes the print job stored in the buffer (step S105). At this time, the controller 490 can control, on the basis of the shipment timing information, the timing at which the image processor 420 executes the print job. For example, the image processor 420 receives the print job generated by the print job generator 330 in advance and stores the print job in a buffer before the timing for sending a product, and when the timing for sending the product has come, the image processor 420 can execute the print job stored in the buffer.

Next, the image former 430 prints the document on the sheet (step S107). The controller 490 controls the image forming section 430 so as to form an image on a sheet based on the print image data generated by the image processing section 420.

Next, the sheet conveyor 450 ejects the printed material onto the sheet ejection tray (step S108). The controller 490 controls the sheet conveyance section 450 so as to eject the printed matter on which the image is printed to the sheet ejection tray.

As described above, in the present embodiment, the printing list generator 315 can control the timing of generation of the print job on the basis of the shipment timing information. In addition, the print job generator 330 can control the timing of transmission of the print job on the basis of the shipment timing information. Furthermore, the controller 490 can control the timing of execution of the print job on the basis of the shipment timing information.

(Example of Pattern Table for Leaflet to be Packed with Product)

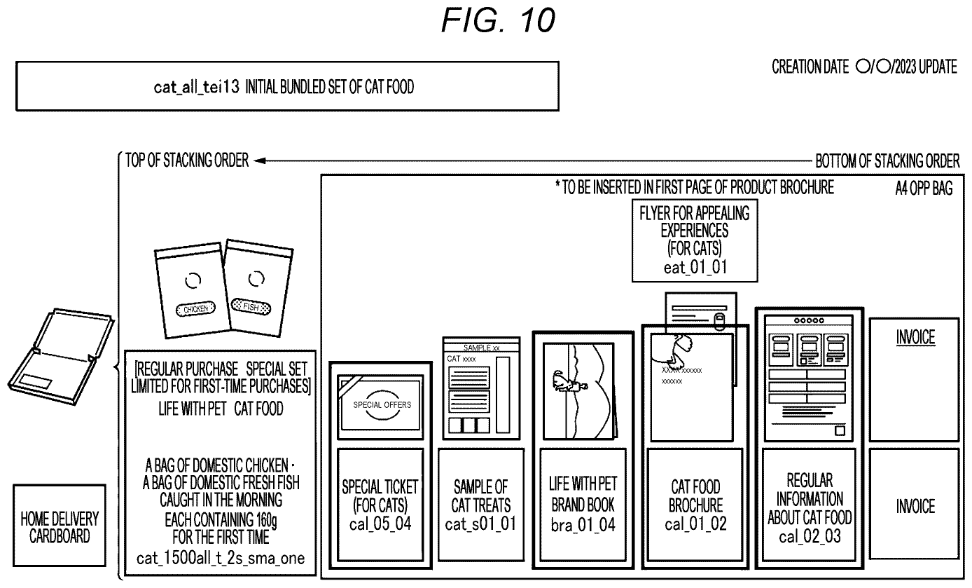

FIG. 10 is a schematic diagram illustrating a pattern table of a flyer to be bundled with a product; and The pattern table is a table which shows an image of a flyer for each page, a description of the image, a file name, and the stacking order of the pages. FIG. 19 illustrates a pattern table for a flyer bundled with cat food. The pattern table in FIG. 19 illustrates that the flyer is bundled with the product at the time of the first regular purchase and is sent to the customer.

### (Current Shipping Operation as Comparative Example)

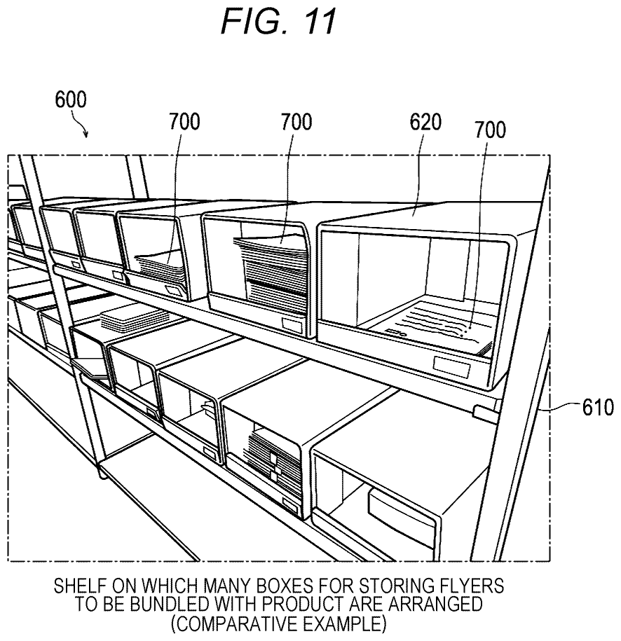

FIG. 11 is a schematic diagram illustrating a shelf 610 on which many boxes 620 for storing the flyers 700 are arranged. At present, a shelf 610 is installed in a leaflet storage place 600 of an EC-specialized distribution center 30, and a large number of boxes 620 for storing leaflets 700 are arranged side by side on the shelf 610. The worker picks a flyer 700 from the shelf 610 on which the corresponding flyer 700 is placed according to a product to be sent and packages the flyer 700 together with the product when shipping the product.

However, the flyer 700 to be bundled with a product has various patterns depending on the product, regular purchase, the number of purchase, and the like. In addition, when there are a plurality of flyers 700 to be bundled with the product, the stacking order is also usually designated by the brand owner in advance. The worker manually picks the flyer 700 while looking at the pattern table of the flyer 700. Picking of the leaflet 700 is performed manually, so that a mistake tends to occur.

As described above, under the current situation, a worker creates a set of flyers 700 in advance in his/her spare time for each purchased product or for each number of purchases, for example, and when picking a product, the worker also picks the created set of flyers 700. However, there is a case where a flyer 700 to be bundled with a product is changed depending on products, regular purchases, the number of purchases, or the like. In addition, a flyer 700 to be bundled may be frequently changed depending on the season, a model change of products, or the like. In such a case, the amount of work of the worker at the site where the product is shipped increases. Further, in such a case, flyers 700 which cannot be used have to be discarded, although the flyers 700 which can be used even after the change may be extracted from the set and used.

### (Effect of Image Forming System 500 According to Present Embodiment)

The image forming system 500, the method of controlling the image forming system 500, and the control program according to the present embodiment have the following effects.

The image forming system 500 controls the process of generating the printed material based on the shipment timing information, whereby it is possible to provide the printed material to be bundled with the product in accordance with the schedule of the shipping work for the product. Therefore, it is possible to suppress generation of surplus flyers due to a delay in the shipping work.

As described above, the image forming system 500, the method for controlling the image forming system 500, and the control program have been described in the embodiment. However, it is needless to say that those skilled in the art can appropriately add, modify, and omit the present invention within the scope of the technical idea thereof.

For example, the printing support system 300 may generate a cover letter, an invoice, or a flyer in combination with the input shipping list or information stored in the cart list database 312 or the like in advance without using document data (for example, PDF format) created in advance.

Furthermore, the control program may be provided by a computer-readable recording medium, such as a USB memory, a flexible disk, or a CD-ROM, or may be provided online via a network, such as the Internet. In this case, the control program recorded on the non-transitory computer-readable storage medium is usually transferred to and stored in a memory, a storage, or the like. Furthermore, this control program may be provided, for example, as independent application software, or may be incorporated, as one function of the server, into software of each apparatus.

While the embodiments of the present invention have been described and illustrated in detail, the disclosed embodiments have been created for purposes of illustration and example only, and not limitation. The scope of the present invention should be interpreted by the wording of the accompanying claims.

What is claimed is:

1. An image forming system that generates a printed material to be sent together with a product that has been ordered, the image forming system comprising a hardware processor, wherein the hardware processor controls a process of generating the printed material on the basis of information regarding a timing for sending the product.

2. The image forming system according to claim 1, further comprising an information processing apparatus that generates a print job for generating the printed material on the basis of the order, wherein
the information processing apparatus includes the hardware processor,
the timing regarding sending of the product is a shipment timing for the product, and
the hardware processor controls a generation timing of generation of the print job on the basis of the shipment timing.

3. The image forming system according to claim 1, further comprising an information processing apparatus that generates a print job for generating the printed material on the basis of the order, wherein
the information processing apparatus includes the hardware processor,
the timing regarding sending of the product is a timing based on a date and time of receipt designated by an orderer ordering the product, and
the hardware processor controls a generation timing of generation of the print job on the basis of the timing based on the date and time of receipt.

4. The image forming system according to claim 1, further comprising an information processing apparatus that generates a print job for generating the printed material on the basis of the order, wherein
the information processing apparatus includes the hardware processor,
the timing regarding sending of the product is a shipment timing for the product, and
the hardware processor controls a transmission timing of transmission of the print job to the image forming apparatus on the basis of the shipment timing.

5. The image forming system according to claim 1, further comprising an information processing apparatus that generates a print job for generating the printed material on the basis of the order, wherein
the information processing apparatus includes the hardware processor,
the timing regarding sending of the product is a timing based on a date and time of receipt designated by an orderer ordering the product, and
the hardware processor controls a transmission timing of transmission of the print job to the image forming apparatus on the basis of the timing based on the date and time of receipt.

6. The image forming system according to claim 1, further comprising an image forming apparatus that executes a print job for generating the printed material, the print job being generated on the basis of the order, wherein
the image forming apparatus includes the hardware processor,
the timing regarding sending of the product is a shipment timing for the product, and
the hardware processor controls an execution timing of execution of the print job on the basis of the shipment timing for the product.

7. The image forming system according to claim 1, further comprising an image forming apparatus that executes a print job for generating the printed material, the print job being generated on the basis of the order, wherein
the image forming apparatus includes the hardware processor,
the timing regarding sending of the product is a timing based on a date and time of receipt designated by an orderer ordering the product, and
the hardware processor controls an execution timing of execution of the print job on the basis of the timing based on the date and time of receipt.

8. The image forming system according to claim 1, further comprising an information processing apparatus that generates a print job for generating the printed material on the basis of the order, wherein
the information processing apparatus includes the hardware processor,
the timing regarding sending of the product is a shipment timing for the product, and
the hardware processor selects, on the basis of the shipment timing, an image to be formed on a recording medium on the basis of the print job.

9. The image forming system according to claim 1, further comprising an information processing apparatus that generates a print job for generating the printed material on the basis of the order, wherein
the information processing apparatus includes the hardware processor,
the timing regarding sending of the product is a timing based on a date and time of receipt designated by an orderer ordering the product, and
the hardware processor selects, on the basis of the timing based on the date and time of receipt, an image to be formed on a recording medium on the basis of the print job.

10. The image forming system according to claim 2, wherein the shipment timing includes a work timing for performing a work for shipping the product.

11. The image forming system according to claim 2, wherein the shipment timing is specified based on whether or not the product is in stock.

12. A method for controlling an image forming system for generating a printed material to be sent together with a product that has been ordered, the method comprising controlling a process of generating the printed material on the basis of information regarding a timing for sending the product.

13. A non-transitory computer-readable storage medium storing a control program for causing a computer to execute, in an image forming system that generates a printed material to be sent together with a product that has been ordered, processing including a procedure of controlling a process of generating the printed material on the basis of information regarding a timing for sending the product.
